(19) United States
(12) Patent Application Publication
(10) Pub. No.: US 2025/0301454 A1
(43) Pub. Date: Sep. 25, 2025

(54) COMMUNICATION METHOD AND COMMUNICATION APPARATUS

(71) Applicant: HUAWEI TECHNOLOGIES CO., LTD., Shenzhen (CN)

(72) Inventors: Chen XU, Hangzhou (CN); Gongzheng ZHANG, Hangzhou (CN); Jian WANG, Hangzhou (CN); Rong LI, Boulogne Billancourt (FR); Jun WANG, Hangzhou (CN)

(73) Assignee: HUAWEI TECHNOLOGIES CO., LTD., Shenzhen (CN)

(21) Appl. No.: 19/231,805

(22) Filed: Jun. 9, 2025

Related U.S. Application Data
(63) Continuation of application No. PCT/CN2022/140179, filed on Dec. 19, 2022.

(51) Int. Cl. H04W 72/044; H04L 5/00

(52) U.S. Cl. CPC H04W 72/044; H04L 5/0048

(57) ABSTRACT

A communication method and a communication apparatus. The method includes: a first apparatus receives a signal from a second apparatus through a first channel, where the signal is generated by the second apparatus based on a first transmitter configuration; determines a channel feature of the first channel based on the received signal; determines a second transmitter configuration based on the channel feature, where the second transmitter configuration indicates at least a processing block configuration, and the processing block configuration indicates a processing granularity for performing signal processing; and sends the second transmitter configuration to the second apparatus. In this way, the second apparatus can update a transmitter configuration in real time without affecting signal transmission, thereby avoiding a problem that the transmitter configuration is no longer accurate due to an environment change, and avoiding an extra delay and training overheads.

### CROSS-REFERENCE TO RELATED APPLICATIONS

This application is a continuation of International Application No. PCT/CN2022/140179, filed on Dec. 19, 2022, the disclosure of which is hereby incorporated by reference in its entirety.

### TECHNICAL FIELD

Embodiments relate to the communication field, and to a communication method and a communication apparatus.

### BACKGROUND

Artificial intelligence (AI) technologies have been fully applied in fields such as image processing and natural language processing. Frequently-used AI technologies include, for example, reinforcement learning, supervised learning, and unsupervised learning. As AI technologies become increasingly mature, AI plays an important role in promoting evolution of mobile communication network technologies. For example, the AI technologies may be applied to a network layer and a physical layer. Currently, research on applying the AI technologies to the physical layer mainly focuses on module replacement of a signal processing module. For example, an offline trained model may be deployed in a system. However, an actual environment of the system is not completely consistent with a training environment, for example, the environment of the system changes with time. As a result, model precision is reduced. Retraining the model causes a delay and training overheads.

### SUMMARY

Embodiments provide a communication solution. A first apparatus can determine a transmitter configuration based on a received signal, so that a second apparatus that sends the signal can update the transmitter configuration in real time. In this way, a transmitter configuration can be updated without affecting signal transmission, thereby avoiding an extra delay.

According to a first aspect, a communication method is provided. The method includes: a first apparatus receives a signal from a second apparatus through a first channel, where the signal is generated by the second apparatus based on a first transmitter configuration; the first apparatus determines a channel feature of the first channel based on the signal; the first apparatus determines a second transmitter configuration based on the channel feature, where the second transmitter configuration indicates at least a processing block configuration, and the processing block configuration indicates a processing granularity for performing signal processing; and the first apparatus sends the second transmitter configuration to the second apparatus.

It may be understood that the first apparatus may be a communication device or a chip (system) on the communication device. In addition, “sending to the second apparatus” indicates a transmission direction of the second transmitter configuration, where the second apparatus is a destination, and includes directly sending to the second apparatus or indirectly sending to the second apparatus through a transmitter. Similarly, “receiving a signal from a second apparatus” indicates that a source of the signal is the second apparatus, and includes directly receiving the signal from the second apparatus or indirectly receiving information from the second apparatus through a receiver.

In this manner, the first apparatus can determine a transmitter configuration based on a received signal, so that the second apparatus that sends the signal can update the transmitter configuration in real time. In this way, the transmitter configuration can be updated without affecting signal transmission, thereby avoiding a problem that the transmitter configuration is no longer accurate due to an environment change, and avoiding an extra delay and training overheads.

In some embodiments of the first aspect, the second transmitter configuration further indicates a channel feature codeword that indicates a quantization result of the channel feature. In this way, the first apparatus may provide the channel feature codeword to the second apparatus through the second transmitter configuration, so that the second apparatus can adjust an output capability of the second apparatus in real time.

In some embodiments of the first aspect, the second transmitter configuration further indicates a channel awareness mask that indicates a location that is of a time-frequency resource and at which a predetermined modulation scheme is used in a single processing block. In this way, even when channel mismatch occurs, the second apparatus can still use the predetermined modulation scheme at the indicated location based on the channel awareness mask, thereby reducing a performance loss without retraining.

In some embodiments of the first aspect, the channel awareness mask includes an index of a frequency domain resource and an index of a time domain resource. In this way, the location that is of the time-frequency resource and at which the predetermined modulation scheme is used can be indicated in an index form. This manner is simple and easy to implement, and has low transmission overheads.

In some embodiments of the first aspect, the processing block configuration includes a quantity of frequency domain resources and a quantity of time domain resources. In this way, a size of a processing block can be indicated through the quantity of time domain resources and the quantity of the frequency domain resources, so that a receive end and a transmit end determine a granularity for joint signal processing.

In some embodiments of the first aspect, the frequency domain resource includes a physical resource block (PRB), a physical resource element (PRE), or a subcarrier, and the time domain resource includes any one of the following: a symbol, a subframe, or a slot.

In some embodiments of the first aspect, the method further includes: the first apparatus determines the first transmitter configuration; and the first apparatus sends the first transmitter configuration to the second apparatus.

In some embodiments of the first aspect, the first apparatus is used on a network side, and the second apparatus is used on a terminal side. That the first apparatus determines the first transmitter configuration includes: the first apparatus obtains a device capability of the second apparatus in a process in which the second apparatus performs random access; and the first apparatus determines the first transmitter configuration based on the device capability of the second apparatus. In this way, in an initial access process, the first apparatus on the network side can determine the first transmitter configuration.

In some embodiments of the first aspect, the first apparatus is used on a network side, and the second apparatus is used on a terminal side. That the first apparatus determines the first transmitter configuration includes: the first apparatus receives a sounding reference signal from the second apparatus; and the first apparatus determines the first transmitter configuration based on the sounding reference signal through uplink channel measurement. In this way, in an uplink scenario, the first apparatus on the network side can determine the first transmitter configuration based on the sounding reference signal.

In some embodiments of the first aspect, the first apparatus is used on a network side, and the second apparatus is used on a terminal side. That the first apparatus determines the first transmitter configuration includes: the first apparatus sends a channel state information reference signal to the second apparatus; the first apparatus receives a first channel feature codeword from the second apparatus, where the first channel feature codeword is determined by the second apparatus based on the channel state information reference signal; and the first apparatus determines the first transmitter configuration based on a channel feature recovered from the first channel feature codeword. In this way, in a downlink scenario, the first apparatus on the network side can determine the first transmitter configuration based on the first channel feature codeword from the second apparatus on the terminal side.

In some embodiments of the first aspect, both the first apparatus and the second apparatus are used on a terminal side. That the first apparatus determines the first transmitter configuration includes: the first apparatus sends a channel state information reference signal to the second apparatus; the first apparatus receives a recommended transmitter configuration from the second apparatus, where the recommended transmitter configuration is determined by the second apparatus based on the channel state information reference signal; and the first apparatus determines the first transmitter configuration based on the recommended transmitter configuration. In this way, in a sidelink communication scenario, the first apparatus can determine the first transmitter configuration based on the recommended transmitter configuration from the second apparatus.

According to a second aspect, a communication method is provided. The method includes: a second apparatus generates a signal based on a first transmitter configuration and to-be-sent data; the second apparatus sends the signal to a first apparatus through a first channel; and the second apparatus receives a second transmitter configuration from the first apparatus, where the second transmitter configuration indicates at least a processing block configuration, and the processing block configuration indicates a processing granularity for performing signal processing.

It may be understood that the second apparatus may be a communication device or a chip (system) on the communication device. In addition, “sending to the first apparatus” indicates a signal transmission direction, where the first apparatus is a destination, and includes directly sending to the first apparatus or indirectly sending to the first apparatus through a transmitter. Similarly, “receiving a second transmitter configuration from the first apparatus” indicates that a source of the second transmitter configuration is the first apparatus, and includes directly receiving the second transmitter configuration from the first apparatus or indirectly receiving the second transmitter configuration from the first apparatus through a receiver.

In some embodiments of the second aspect, the second transmitter configuration further indicates a channel feature codeword that indicates a quantization result of the channel feature.

In some embodiments of the second aspect, the second transmitter configuration further indicates a channel awareness mask that indicates a location that is of a time-frequency resource and at which a predetermined modulation scheme is used in a single processing block.

In some embodiments of the second aspect, the channel awareness mask includes an index of a frequency domain resource and an index of a time domain resource.

In some embodiments of the second aspect, the processing block configuration includes a quantity of frequency domain resources and a quantity of time domain resources.

In some embodiments of the second aspect, the frequency domain resource includes a physical resource block, a physical resource element, or a subcarrier, and the time domain resource includes any one of the following: a symbol, a subframe, or a slot.

In some embodiments of the second aspect, the first transmitter configuration indicates a first processing block configuration and a first channel awareness mask. That the second apparatus generates the signal based on the first transmitter configuration and the to-be-sent data includes: the second apparatus divides the to-be-sent data into a plurality of processing blocks based on the first processing block configuration; and for to-be-sent data in each of the plurality of processing blocks, generating the signal by using a predetermined modulation scheme at a location that is of a time-frequency resource and that is indicated by the first channel awareness mask and another modulation scheme different from the predetermined modulation scheme at another location.

In some embodiments of the second aspect, the first apparatus is used on a network side, and the second apparatus is used on a terminal side. The method further includes: the second apparatus sends a sounding reference signal to the first apparatus; and the second apparatus receives the first transmitter configuration from the first apparatus.

In some embodiments of the second aspect, the first apparatus is used on a terminal side, and the second apparatus is used on a network side. The method further includes: the second apparatus receives a sounding reference signal from the first apparatus; and the second apparatus determines the first transmitter configuration based on the sounding reference signal.

In some embodiments of the second aspect, the first apparatus is used on a network side, and the second apparatus is used on a terminal side. The method further includes: the second apparatus receives a channel state information reference signal from the first apparatus; the second apparatus determines a first channel feature codeword based on the channel state information reference signal; the second apparatus sends the first channel feature codeword to the first apparatus; and the second apparatus receives the first transmitter configuration from the first apparatus.

In some embodiments of the second aspect, the first apparatus is used on a terminal side, and the second apparatus is used on a network side. The method further includes: the second apparatus sends a channel state information reference signal to the first apparatus; the second apparatus receives a first channel feature codeword from the first apparatus, where the first channel feature codeword is determined by the first apparatus based on the channel state information reference signal; and the second apparatus determines the first transmitter configuration based on a channel feature recovered from the first channel feature codeword.

In some embodiments of the second aspect, both the first apparatus and the second apparatus are used on a terminal side. The method further includes: the second apparatus receives a channel state information reference signal from the first apparatus; the second apparatus determines a recommended transmitter configuration based on the channel state information reference signal; the second apparatus sends the recommended transmitter configuration to the first apparatus; and the second apparatus receives the first transmitter configuration from the first apparatus.

In some embodiments of the second aspect, both the first apparatus and the second apparatus are used on a terminal side. The method further includes: the second apparatus sends a channel state information reference signal to the first apparatus; the second apparatus receives a recommended transmitter configuration from the first apparatus, where the recommended transmitter configuration is determined by the first apparatus based on the channel state information reference signal; and the second apparatus determines the first transmitter configuration based on the recommended transmitter configuration. Optionally, the second apparatus further sends the first transmitter configuration to the first apparatus.

According to a third aspect, a communication apparatus is provided. The communication apparatus includes: a receiving module, configured to receive a signal from a second apparatus through a first channel, where the signal is generated by the second apparatus based on a first transmitter configuration; a processing module, configured to determine a channel feature of the first channel based on the signal, and determine a second transmitter configuration based on the channel feature, where the second transmitter configuration indicates at least a processing block configuration, and the processing block configuration indicates a processing granularity for performing signal processing; and a sending module, configured to send the second transmitter configuration to the second apparatus.

In some embodiments of the third aspect, the second transmitter configuration further indicates a channel feature codeword that indicates a quantization result of the channel feature.

In some embodiments of the third aspect, the second transmitter configuration further indicates a channel awareness mask that indicates a location that is of a time-frequency resource and at which a predetermined modulation scheme is used in a single processing block.

In some embodiments of the third aspect, the channel awareness mask includes an index of a frequency domain resource and an index of a time domain resource.

In some embodiments of the third aspect, the processing block configuration includes a quantity of frequency domain resources and a quantity of time domain resources.

In some embodiments of the third aspect, the frequency domain resource includes a physical resource block, a physical resource element, or a subcarrier, and the time domain resource includes any one of the following: a symbol, a subframe, or a slot.

In some embodiments of the third aspect, the processing module is further configured to determine the first transmitter configuration; and the sending module is further configured to send the first transmitter configuration to the second apparatus.

In some embodiments of the third aspect, the communication apparatus is used on a network side, and the second apparatus is used on a terminal side. The processing module is configured to: obtain a device capability of the second apparatus in a process in which the second apparatus performs random access; and determine the first transmitter configuration based on the device capability of the second apparatus.

In some embodiments of the third aspect, the communication apparatus is used on a network side, and the second apparatus is used on a terminal side. The receiving module is further configured to receive a sounding reference signal from the second apparatus; and the processing module is further configured to determine the first transmitter configuration based on the sounding reference signal through uplink channel measurement.

In some embodiments of the third aspect, the communication apparatus is used on a network side, and the second apparatus is used on a terminal side. The sending module is further configured to send a channel state information reference signal to the second apparatus; the receiving module is further configured to receive a first channel feature codeword from the second apparatus, where the first channel feature codeword is determined by the second apparatus based on the channel state information reference signal; and the processing module is further configured to determine the first transmitter configuration based on a channel feature recovered from the first channel feature codeword.

In some embodiments of the third aspect, both the communication apparatus and the second apparatus are used on a terminal side. The sending module is further configured to send a channel state information reference signal to the second apparatus; the receiving module is further configured to receive a recommended transmitter configuration from the second apparatus, where the recommended transmitter configuration is determined by the second apparatus based on the channel state information reference signal; and the processing module is further configured to determine the first transmitter configuration based on the recommended transmitter configuration.

For example, the processing module may be a processor, the receiving module may be a receiver or an input interface, and the sending module may be a transmitter or an output interface. In addition, the receiving module and the sending module may be combined into a transceiver module, a transceiver, or a communication interface. It may be understood that, if the communication apparatus is a communication device, the receiver, the transmitter, or the transceiver may be implemented by using an antenna, a feeder, a codec, and the like in the apparatus. Alternatively, if the communication apparatus is a chip disposed in the device, the receiving module may be an input interface, an input circuit, a pin, or the like of the chip, and the sending module may be an output interface, an output circuit, a pin, or the like of the chip.

According to a fourth aspect, a communication apparatus is provided, including: a processing module, configured to generate a signal based on a first transmitter configuration and to-be-sent data; a sending module, configured to send the signal to a first apparatus through a first channel; and a receiving module, configured to receive a second transmitter configuration from the first apparatus, where the second transmitter configuration indicates at least a processing block configuration, and the processing block configuration indicates a processing granularity for performing signal processing.

In some embodiments of the fourth aspect, the second transmitter configuration further indicates a channel feature codeword that indicates a quantization result of the channel feature.

In some embodiments of the fourth aspect, the second transmitter configuration further indicates a channel awareness mask that indicates a location that is of a time-frequency resource and at which a predetermined modulation scheme is used in a single processing block.

In some embodiments of the fourth aspect, the channel awareness mask includes an index of a frequency domain resource and an index of a time domain resource.

In some embodiments of the fourth aspect, the processing block configuration includes a quantity of frequency domain resources and a quantity of time domain resources.

In some embodiments of the fourth aspect, the frequency domain resource includes a physical resource block, a physical resource element, or a subcarrier, and the time domain resource includes any one of the following: a symbol, a subframe, or a slot.

In some embodiments of the fourth aspect, the first transmitter configuration indicates a first processing block configuration and a first channel awareness mask. The processing module is further configured to: divide the to-be-sent data into a plurality of processing blocks based on the first processing block configuration; and for to-be-sent data in each of the plurality of processing blocks, generate the signal by using a predetermined modulation scheme at a location that is of a time-frequency resource and that is indicated by the first channel awareness mask and another modulation scheme different from the predetermined modulation scheme at another location.

In some embodiments of the fourth aspect, the first apparatus is used on a network side, and the communication apparatus is used on a terminal side. The sending module is further configured to send a sounding reference signal to the first apparatus; and the receiving module is further configured to receive the first transmitter configuration from the first apparatus.

In some embodiments of the fourth aspect, the first apparatus is used on a terminal side, and the communication apparatus is used on a network side. The receiving module is further configured to receive a sounding reference signal from the first apparatus; and the processing module is further configured to determine the first transmitter configuration based on the sounding reference signal.

In some embodiments of the fourth aspect, the first apparatus is used on a network side, and the communication apparatus is used on a terminal side. The receiving module is further configured to receive a channel state information reference signal from the first apparatus; the processing module is further configured to determine a first channel feature codeword based on the channel state information reference signal; the sending module is further configured to send the first channel feature codeword to the first apparatus; and the receiving module is further configured to receive the first transmitter configuration from the first apparatus.

In some embodiments of the fourth aspect, the first apparatus is used on a terminal side, and the communication apparatus is used on a network side. The sending module is further configured to send a channel state information reference signal to the first apparatus; the receiving module is further configured to receive a first channel feature codeword from the first apparatus, where the first channel feature codeword is determined by the first apparatus based on the channel state information reference signal; and the processing module is further configured to determine the first transmitter configuration based on a channel feature recovered from the first channel feature codeword.

In some embodiments of the fourth aspect, both the first apparatus and the communication apparatus are used on a terminal side. The receiving module is further configured to receive a channel state information reference signal from the first apparatus; the processing module is further configured to determine a recommended transmitter configuration based on the channel state information reference signal; the sending module is further configured to send the recommended transmitter configuration to the first apparatus; and the receiving module is further configured to receive the first transmitter configuration from the first apparatus.

In some embodiments of the fourth aspect, both the first apparatus and the communication apparatus are used on a terminal side. The sending module is further configured to send a channel state information reference signal to the first apparatus; the receiving module is further configured to receive a recommended transmitter configuration from the first apparatus, where the recommended transmitter configuration is determined by the first apparatus based on the channel state information reference signal; and the processing module is further configured to determine the first transmitter configuration based on the recommended transmitter configuration.

For example, the processing module may be a processor, the receiving module may be a receiver or an input interface, and the sending module may be a transmitter or an output interface. In addition, the receiving module and the sending module may be combined into a transceiver module, a transceiver, or a communication interface. It may be understood that, if the communication apparatus is a communication device, the receiver, the transmitter, or the transceiver may be implemented by using an antenna, a feeder, a codec, and the like in the apparatus. Alternatively, if the communication apparatus is a chip disposed in the device, the receiving module may be an input interface, an input circuit, a pin, or the like of the chip, and the sending module may be an output interface, an output circuit, a pin, or the like of the chip.

According to a fifth aspect, a communication apparatus is provided. The communication apparatus includes a processor, a transceiver, and a memory. The memory stores instructions executed by the processor. When the instructions are executed by the processor, the communication apparatus is enabled to implement the method according to any one of the first aspect or embodiments of the first aspect.

According to a sixth aspect, a communication apparatus is provided. The communication apparatus includes a processor, a transceiver, and a memory. The memory stores instructions executed by the processor. When the instructions are executed by the processor, the communication apparatus is enabled to implement the method according to any one of the second aspect or embodiments of the second aspect.

According to a seventh aspect, a non-transitory computer-readable storage medium is provided. The non-transitory computer-readable storage medium stores computer-executable instructions. When the computer-executable instructions are executed by a processor, an operation of the method according to any one of the first aspect or embodiments of the first aspect is implemented, or an operation of the method according to any one of the second aspect or embodiments of the second aspect is implemented.

According to an eighth aspect, a chip or a chip system is provided. The chip or the chip system includes a processing circuit, configured to perform an operation of the method according to any one of the first aspect or embodiments of the first aspect, or implement an operation of the method according to any one of the second aspect or embodiments of the second aspect.

According to a ninth aspect, a computer program or a computer program product is provided. The computer program or the computer program product is tangibly stored in a non-transitory computer-readable medium and includes computer-executable instructions. When the computer-executable instructions are executed, an operation of the method according to any one of the first aspect or embodiments of the first aspect is implemented, or an operation of the method according to any one of the second aspect or embodiments of the second aspect is implemented.

According to a tenth aspect, a communication system is provided, including a first apparatus and a second apparatus. The first apparatus includes the communication apparatus according to any one of the third aspect or embodiments of the third aspect or the communication apparatus according to the fifth aspect. The second apparatus includes the communication apparatus according to any one of the fourth aspect or embodiments of the fourth aspect or the communication apparatus according to the sixth aspect.

According to an eleventh aspect, a communication method is provided, including: a first apparatus performs the method according to any one of the first aspect or embodiments of the first aspect, and a second apparatus performs the method according to any one of the second aspect or embodiments of the second aspect.

For effects of the second aspect to the eleventh aspect, refer at least to the description of the first aspect.

It should be understood that the content described in the summary is not intended to limit key or important features of embodiments or limit the scope of the embodiments. Other features of the embodiments are readily understood through the following descriptions.

### BRIEF DESCRIPTION OF DRAWINGS

With reference to the accompanying drawings and the following detailed descriptions, the foregoing and other features, advantages, and aspects of embodiments become more apparent. In the accompanying drawings, same or similar reference numerals indicate same or similar elements.

FIG. 1 is a diagram of a physical layer signal processing procedure;

FIG. 2 is a diagram of an example scenario in which an embodiment can be implemented;

FIG. 3 is a diagram of signaling exchange in a communication process according to some embodiments;

FIG. 4 is a diagram of a communication process according to some embodiments;

FIG. 5 is another diagram of a communication process according to some embodiments;

FIG. 6A is a diagram of a corresponding constellation diagram configuration according to some embodiments;

FIG. 6B is an example of twelve irregular constellation mapping tables according to some embodiments;

FIG. 6C is a diagram of block error ratio performance according to some embodiments;

FIG. 7 is a schematic flowchart of a process of determining a first transmitter configuration according to some embodiments;

FIG. 8 is a schematic flowchart of a process of determining a first transmitter configuration according to some embodiments;

FIG. 9 is a schematic flowchart of a process of determining a first transmitter configuration according to some embodiments;

FIG. 10 is a schematic flowchart of a process of determining a first transmitter configuration according to some embodiments;

FIG. 11 is a schematic block diagram of a communication apparatus according to some embodiments;

FIG. 12 is a schematic block diagram of another communication apparatus according to some embodiments; and

FIG. 13 is a schematic block diagram of an example device that may be used to implement an embodiment.

### DETAILED DESCRIPTION OF EMBODIMENTS

The following describes embodiments with reference to the accompanying drawings. Although some embodiments are shown in the accompanying drawings, it should be understood that the embodiments can be implemented in various forms, and should not be construed as being limited to embodiments described herein, and instead, these embodiments are provided for a more thorough and complete understanding of the solutions of the embodiments. It should be understood that the accompanying drawings and embodiments are merely used as examples and are not intended as limiting.

In the descriptions of embodiments, the term “including” and similar terms thereof should be understood as non-exclusive inclusions, that is, “including, but not limited to”. The term “based on” should be understood as “at least partially based on”. The term “one embodiment” or “this embodiment” should be understood as “at least one embodiment”. The terms “first”, “second”, and the like may indicate different objects or a same object. The term “and/or” indicates at least one of two items associated with the term. For example, “A and/or B” indicates A, B, or A and B. Other explicit and implicit definitions may also be included below.

It should be noted that, regarding “sending information to A” in the embodiments, “to A” merely indicates an information transmission direction, A is a destination, and it is not limited that “sending information to A” is definitely sending on an air interface. “Sending information to A” includes directly sending information to A and indirectly sending information to A through a transmitter. Therefore, “sending information to A” may alternatively be understood as “outputting information to A”. Similarly, “receiving information from A” indicates that a source of the information is A, and includes directly receiving information from A and indirectly receiving information from A through a receiver. Therefore, “receiving information from A” may alternatively be understood as “inputting information from A”.

It may be understood that, in the embodiments, an “indication” may include a direct indication, an indirect indication, an explicit indication, and an implicit indication. When a piece of indication information is described as indicating A, it may be understood that the indication information carries A, directly indicates A, or indirectly indicates A. In the embodiments, information indicated by the indication information is referred to as to-be-indicated information. In a specific implementation process, there are many manners of indicating the to-be-indicated information. For example, the manners include, but are not limited to, a manner in which the to-be-indicated information, for example, the to-be-indicated information itself or an index of the to-be-indicated information, may be directly indicated, or a manner in which the to-be-indicated information may be indirectly indicated by indicating other information. There is an association relationship between the other information and the to-be-indicated information. Alternatively, only a part of the to-be-indicated information may be indicated, and the other part of the to-be-indicated information is known or pre-agreed on. For example, specific information may alternatively be indicated by using an arrangement sequence of a plurality of pieces of information that is pre-agreed on (for example, stipulated in a protocol), to reduce indication overheads to some extent. The to-be-indicated information may be sent as a whole, or may be divided into a plurality of pieces of sub-information for separate sending. In addition, sending periodicities and/or sending occasions of these pieces of sub-information may be the same or may be different. A specific sending method is not limited. The sending periodicities and/or the sending occasions of these pieces of sub-information may be predefined, for example, predefined according to a protocol, or may be configured by a transmitting end device by sending configuration information to a receiving end device.

Embodiments may be implemented according to any appropriate communication protocol, including, but not limited to, cellular communication protocols such as the 3rd generation (3G), the 4th generation (4G), the 5th generation (5G), and the 6th generation (6G), wireless local area network communication protocols such as the Institute of Electrical and Electronics Engineers (IEEE) 802.11, and/or any other protocols currently known or developed in the future.

Solutions in embodiments are applied to a communication system complying with any appropriate communication protocol, for example, a general packet radio service (GPRS), a global system for mobile communications (GSM), an enhanced data rate for GSM evolution (EDGE) system, a universal mobile telecommunications system (UMTS), a long term evolution (LTE) system, a wideband code division multiple access (WCDMA) system, a code division multiple access 2000 (CDMA 2000) system, a time division-synchronization code division multiple access (TD-SCDMA) system, a frequency division duplex (FDD) system, a time division duplex (TDD) system, a 5th generation (5G) system or a new radio (NR) system, and a 6th generation (6G) system.

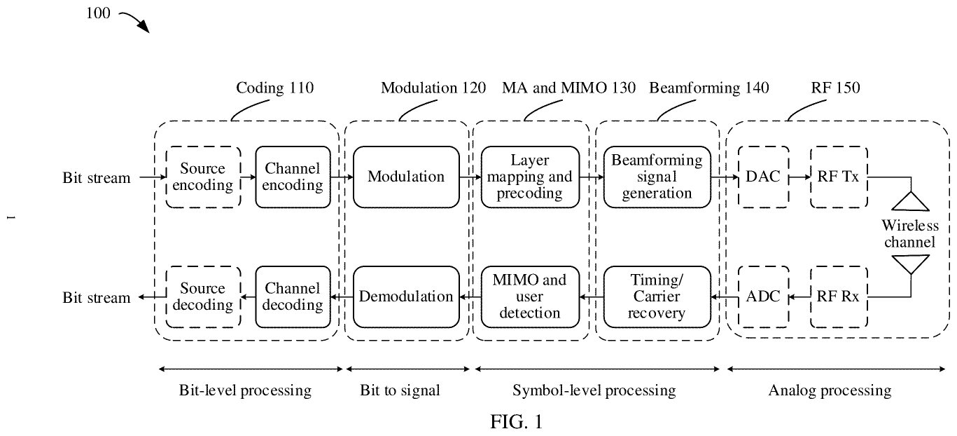

AI technologies may be applied to a network layer (for example, network optimization, mobility management, and resource allocation) and a physical layer (for example, channel encoding and decoding, channel prediction, and a receiver). AI research on the physical layer includes a focus on module replacement of a physical layer signal processing module. FIG. 1 is a diagram of a physical layer signal processing procedure 100, including coding 110, modulation 120, layer mapping (LM) and multi-input multi-output (MIMO) 130, beamforming 140, and radio frequency (RF) 150. Application of the AI technologies at the physical layer can achieve definite effects in a plurality of aspects: joint optimization of a plurality of modules, adaptive environment adjustment, joint processing of high-dimensional data, and a data-driven algorithm for a complex and difficult modeling problem. However, for a physical layer module, an independent optimization algorithm of each module is extremely close to an upper performance limit, and a gain space obtained through simple module replacement is not large.

In some existing manners, a communication system may be modeled as a self-encoder structure. An offline training model may be deployed in the system. When an actual environment does not match a system model, training data may be sent for online training, so that the system can adapt to a new environment. That is, when a system environment changes, a receive end and a transmit end need to perform end-to-end training again, to maintain better performance of the system. However, it is difficult to implement accurate gradient back propagation during real-time training, and real-time training causes a delay and training overheads.

To resolve the foregoing problem and another potential problem, the embodiments provide a communication method. Embodiments relate to the term “processing block (PB)”. The processing block may represent a size of a data block for signal processing, such as a granularity for signal processing. For example, the processing block may include n frequency domain resources and m time domain resources, where n and m are positive integers. In embodiments, a first apparatus receives a signal from a second apparatus through a first channel, where the signal is generated by the second apparatus based on a first transmitter configuration; the first apparatus determines a channel feature of the first channel based on the signal; the first apparatus determines a second transmitter configuration based on the channel feature of the first channel, where the second transmitter configuration indicates at least a processing block configuration, and the processing block configuration indicates a processing granularity for performing signal processing; and the first apparatus sends the second transmitter configuration to the second apparatus. In this way, the second apparatus can update a transmitter configuration in real time without affecting signal transmission, thereby avoiding a problem that the transmitter configuration is no longer accurate due to an environment change, and avoiding an extra delay and training overheads.

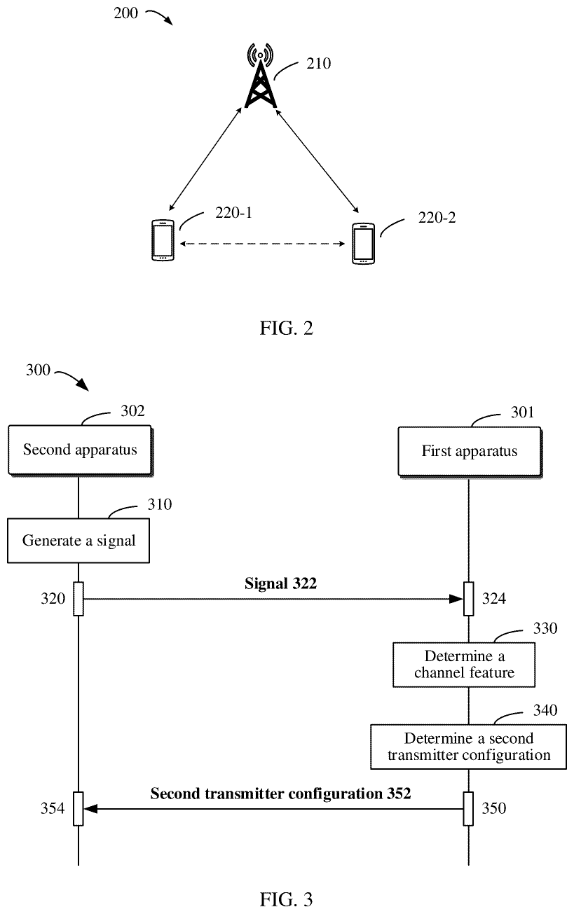

FIG. 2 is a diagram of an example scenario 200 in which an embodiment can be implemented. In the scenario 200, a network device 210, a terminal device 220-1, and a terminal device 220-2 are shown. The terminal device 220-1 and the terminal device 220-2 may be separately or collectively referred to as a terminal device 220. The network device 210 and the terminal device 220 can communicate with each other. The terminal device 220-1 and the terminal device 220-2 can communicate with each other.

The terminal device 220 may include a device that provides voice and/or data connectivity for a user. For example, the terminal device 220 includes a device that provides voice for a user, or includes a device that provides data connectivity for a user, or includes a device that provides voice and data connectivity for a user. For example, the terminal device may include a handheld device having a wireless connection function or a processing device connected to a wireless modem. The terminal device 220 may be user equipment (UE), a wireless terminal device, a mobile terminal device, a device-to-device (D2D) communication terminal device, a a vehicle-to-everything (V2X) terminal device, machine-to-machine/machine-type communication (M2M/MTC) terminal device, an internet of things (IoT) terminal device, a subscriber unit, a subscriber station, a mobile station, a remote station, an access point (AP), a remote terminal device, an access terminal device, a user terminal device, a user agent, a user device, a satellite, an uncrewed aerial vehicle, a balloon, an aircraft, or the like. For example, the terminal device 220 may include a mobile phone (or referred to as a “cellular” phone), a computer having a mobile terminal device, or a portable, pocket-sized, handheld, computer-built-in mobile apparatus. For example, the terminal device 220 may be a device such as a personal communication service (PCS) phone, a cordless telephone set, a session initiation protocol (SIP) phone, a wireless local loop (WLL) station, or a personal digital assistant (PDA). The terminal device 220 may alternatively include a limited device, for example, a device with relatively low power consumption, a device with a limited storage capability, or a device with a limited computing capability. For example, the terminal device 220 includes an information sensing device such as a barcode, radio frequency identification (RFID), a sensor, a global positioning system (GPS), or a laser scanner. As an example instead of a limitation, the terminal device 220 may alternatively be a wearable device. The wearable device may also be referred to as a wearable intelligent device, an intelligent wearable device, or the like, and is a general term for wearable devices developed by intelligently designing everyday wearing by applying a wearable technology. If the various terminal devices described above are located in a vehicle (for example, placed in the vehicle or installed in the vehicle), the terminal devices may be all considered as vehicle-mounted terminal devices. For example, the vehicle-mounted terminal device is also referred to as an on-board unit (OBU).

The network device 210 includes, for example, an access network (AN) device, for example, a base station or an access point, and may be a device that communicates with a wireless terminal device 220 over an air interface in an access network by using one or more cells, or a transmitting and receiving point (TRP), a transmitting point (TP), a mobile switching center, a device that undertakes a base station function in device-to-device (D2D), vehicle-to-everything (V2X), and machine-to-machine (M2M) communication, and the like. Alternatively, the network device 210 may be a road side unit (RSU) in a vehicle-to-everything (V2X) technology. The network device 210 may include an evolved NodeB (NodeB or eNB or e-NodeB, evolved NodeB) in a long term evolution (LTE) or long term evolution-advanced (LTE-A) system, may include a next generation NodeB (gNB) in an evolved packet core (EPC) network, a 5th generation (5G) mobile communication technology, or a new radio (NR) system (also referred to as an NR system for short), or may include a central unit (CU) and a distributed unit (DU) in a cloud radio access network (Cloud RAN) system, a satellite, an uncrewed aerial vehicle, a balloon, an aircraft, or the like. This is not limited.

FIG. 3 is a diagram of signaling exchange in an example communication process 300 according to some embodiments. A first apparatus 301 and a second apparatus 302 are used in the process 300. The first apparatus 301 may be implemented on a network side, for example, a network device 210 shown in FIG. 2 is included in the network device 210. Alternatively, the first apparatus 301 may be implemented on a terminal side, for example, a terminal device 220 shown in FIG. 2 is included in the terminal device 220. The second apparatus 302 may be implemented on a network side, for example, the network device 210 shown in FIG. 2 is included in the network device 210. Alternatively, the second apparatus 302 may be implemented on a terminal side, for example, the terminal device 220 shown in FIG. 2 is included in the terminal device 220.

For example, the second apparatus 302 may be implemented as a transmitter or included in a transmitter, and the first apparatus 301 may be implemented as a receiver or included in a receiver. In this embodiment, the transmitter and the receiver may perform joint signal processing through a neural network, so that a joint signal gain can be obtained.

In the process 300, the second apparatus 302 generates a signal based on a first transmitter configuration and to-be-sent data (310). In some examples, the to-be-sent data may be obtained based on a bit stream, and the signal may be a symbol stream. For example, the to-be-sent data may include uncoded data, may include a bit stream obtained through source encoding, or may include a bit stream obtained through source and channel encoding. This is not limited. For example, the generated signal may be a transmit symbol stream. In some examples, processing of the to-be-sent data may include one or more of operations such as coding, modulation, beamforming, and analog-to-digital conversion.

In this embodiment, the second apparatus 302 may have a transmitter configuration. For example, the transmitter configuration may be preconfigured, may be predetermined by the second apparatus 302, or may be previously received from the first apparatus 301. For example, the transmitter configuration may include a processing block configuration, which is represented as, for example, PB=(n, m), where n represents a quantity of frequency domain resources, and m represents a quantity of time domain resources. For example, the frequency domain resource may be a physical resource block, a physical resource element, or a subcarrier. For example, the time domain resource may be a symbol, a subframe, or a slot. An example in which the frequency domain resource is a PRB (or an RB for short) and the time domain resource is an orthogonal frequency division multiplexing (OFDM) symbol is used. A value of n may be 1, 2, 4, or 8, and a value of m may be 1, 2, N_{symb}/2, or N_{symb}, where N_{symb} represents a quantity of symbols in each slot. As an example, it may be assumed that, in the process 310, the transmitter configuration at the second apparatus 302 is the first transmitter configuration.

In some embodiments, the first transmitter configuration may include a first processing block configuration, and the first processing block configuration may represent a processing granularity for signal processing. For example, the first processing block configuration may indicate a quantity of frequency domain resources and a quantity of time domain resources. For example, the first processing block configuration may indicate n RBs and m OFDM symbols, where n=n1, and m=m1, and is represented as, for example, PB=(n1, m1). In some embodiments, the second apparatus 302 may divide the to-be-sent data, for example, into a plurality of processing blocks based on the first processing block configuration, where a size of each processing block is (n1, m1). The second apparatus 302 may separately perform processing on a plurality of processing blocks. For example, processing on each processing block is the same or similar. That is, a processing manner for different processing blocks is reused.

For example, it is assumed that the second apparatus 302 needs to send data including four RBs and fourteen OFDM symbols. If the first processing block configuration indicates that PB=(1, 1), it indicates that data including one RB (including twelve subcarriers) and one OFDM symbol may be obtained by performing inference for one time, that is, 12× 1 complex symbols are output by performing inference for one time. Therefore, to obtain data including four RBs and fourteen OFDM symbols, the second apparatus 302 may perform inference on a (same) transmitter neural network for a total of 4×14 times. If the first processing block configuration indicates that PB=(4, 7), the second apparatus 302 may perform inference on the transmitter neural network for a total of 1×2 times, and 48×7 complex symbols are output by performing inference for one time.

In some embodiments, the first transmitter configuration may include a first channel feature codeword (CFC), and the first channel feature codeword may indicate a quantization result of a channel feature. For example, the first channel feature codeword may be represented by a plurality of bits, for example, 32 bits. In some embodiments, the second apparatus 302 may determine the channel feature based on the first channel feature codeword. In some embodiments, the second apparatus 302 may perform processing on each of a plurality of processing blocks based on the first channel feature codeword. For example, the processing may include channel encoding and the like.

In some embodiments, the first transmitter configuration may include the first processing block configuration and the first channel feature codeword. Pseudo-code sent by the second apparatus 302 may be represented as:

```
for l = 0 to M/m1 − 1
    for k = 0 to N/n1 − 1
      s_{k,l}= fₜₓ^{n1,m1} (b, c, Q)
  end for
end for
```

where M represents a quantity of scheduled transmit OFDM symbols, N represents a quantity of scheduled transmit RBs, s_{k,l} represents a transmit symbol vector with a length of 12×n1×m1, k represents a sequence number of an RB, l represents a sequence number of an OFDM symbol, fₜₓ^{n1,m1} represents a transmitter in a configuration of PB=(n1, m1), b represents to-be-sent data that is input, c represents a channel feature codeword, and Q represents a compression ratio of a transmitter. For example, if an input dimension is 4, and a corresponding output dimension is 1, Q=4.

In some embodiments, the first transmitter configuration may include a first channel awareness mask, where the first channel awareness mask may indicate a location that is of a time-frequency resource and at which a predetermined modulation scheme is used in a single processing block. For example, the first channel awareness mask may indicate a location of a time-frequency resource through a first frequency domain range and a first time domain range, and modulation is performed using a predetermined modulation scheme at the indicated location of the time-frequency resource. For example, the predetermined modulation scheme may include any one of the following: amplitude shift keying (ASK) modulation, phase shift keying (PSK) modulation, frequency shift keying (FSK) modulation, quadrature amplitude modulation (QAM), and the like. For example, a channel awareness mask includes an index of a frequency domain resource and an index of a time domain resource.

In some embodiments, for each processing block, the second apparatus 302 may generate a signal by using a predetermined modulation scheme at a location that is of a time-frequency resource and that is indicated by the first channel awareness mask and another modulation scheme different from the predetermined modulation scheme at another location. For example, the another modulation scheme may be based on an irregular constellation mapping table. The irregular constellation mapping table may be jointly optimized based on a PB, but may be limited to no joint modulation between resource elements (RE). For example, if the first processing block configuration indicates that PB=(n1, m1), the second apparatus 302 may determine 12×n1×m1 constellation diagrams, corresponding to 12×n1×m1 REs in an RB.

In some embodiments, the first transmitter configuration may include the first processing block configuration and the first channel awareness mask. Pseudo-code sent by the second apparatus 302 may be represented as:

```
for l = 0 to M/m1 − 1
  for k = 0 to N/n1 − 1
    for i = 0 to N_{sc}^{rb} × n1 − 1
      if i % N_{sc}^{rb} in sc_index or l in sym_index
        s_{k×M/n1+i,l} = QAM(b, Q)
      else
        s_{k×M/n1+i,l} = C_{i,l}^{n,m} (b, Q)
      end if
    end for
  end for
end for
```

where N_{sc}^{rb} represents a quantity of subcarriers in an RB, s_{k×M/n1+i,l} represents a modulation symbol corresponding to a location

$$( k \times \frac{M}{n 1} + i , l ) ,$$

QAM (b, Q) represents the QAM modulation, b represents an input bit, Q represents a modulation order, C_{i,l}^{n,m}(b, Q) represents an irregular constellation diagram of PB=(n1, m1), i represents a sequence number of a subcarrier in an RB, l represents a sequence number of an OFDM symbol, sc_index represents an index of a subcarrier indicated by the first channel awareness mask, and sym_index represents an index of an OFDM symbol indicated by the first channel awareness mask. It may be understood that, in the embodiment in which the first transmitter configuration includes the first channel awareness mask, although an RE constellation diagram is jointly optimized in a PB, an RE is independent when modulation is performed each time.

In this way, a processing granularity of the second apparatus 302 may be controlled or limited through the first processing block configuration. For example, when PB=(1, 1), that is, a processing block includes one RB and one OFDM symbol, the second apparatus 302 may process data including one RB (including twelve subcarriers) and one OFDM symbol at a time, that is, data corresponding to 12×1 modulation symbols. However, it may be understood that, even if the second apparatus 302 has a strong processing capability, the second apparatus 302 does not perform joint transmission of symbols across PBs. The neural network can obtain a performance gain of joint processing of high-dimensional data, but it is almost impossible for the second apparatus 302 to enumerate permutations and combinations of the high-dimensional data. Therefore, in this embodiment, the processing granularity is limited through the first processing block configuration, so that performance of a transmitter and a receiver and implementation complexity can be balanced, thereby improving scalability and reusability.

The second apparatus 302 sends the signal 322 to the first apparatus 301 (320). Correspondingly, the first apparatus 301 receives the signal 322 (334). For example, the second apparatus 302 may send the signal 322 through a first channel, where the first channel is a data channel. For example, the second apparatus 302 is implemented on a network side, the first apparatus 301 is implemented on a terminal side, and the first channel may be a physical downlink shared channel (PDSCH). For example, the second apparatus 302 is implemented on a terminal side, the first apparatus 301 is implemented on a network side, and the first channel may be a physical uplink shared channel (PUSCH). For example, both the first apparatus 301 and the second apparatus 302 are implemented on a terminal side, and the first channel may be a physical sidelink shared channel (PSSCH).

The first apparatus 301 determines a channel feature (330). In some embodiments, the first apparatus 301 may determine a channel feature of the first channel based on reception of the signal 322 that passes through the first channel. For example, the channel feature of the first channel may be used by the first apparatus 301 to determine a second transmitter configuration.

In some embodiments, the first apparatus 301 may further determine (for example, recover) data based on the signal 322. For example, the data may be a bit stream. For example, the first apparatus 301 may process the received signal 322 to determine data. In some examples, processing on the signal 322 may include one or more of operations such as digital-to-analog conversion, timing, carrier recovery, demodulation, and decoding. For example, the first apparatus 301 may further determine a log likelihood ratio (LLR) of each bit in the bit stream based on the signal 322. For example, the LLR may be input to a channel decoder for signal processing. In some embodiments, a freer algorithm may be implemented at the first apparatus 301 than at the second apparatus 302. For example, a capability of the first apparatus 301 may not be limited, for example, joint processing of symbols may be performed across PBs at the first apparatus 301. In this way, a processing capability of the first apparatus 301 can be fully used.

In some embodiments, the channel feature of the first channel may represent a statistical feature of the first channel, and may be represented as, for example, a channel matrix, three-dimensional information of space-time-frequency of a multipath component in the channel, or other information. Optionally, the channel feature may also be referred to as a long-term channel feature or another name. This is not limited. In this way, the first apparatus 301 may determine the channel feature in a process of receiving a signal. Therefore, in this solution, a pilot signal does not need to be independently sent in advance for channel estimation, which can reduce signaling overheads.

The first apparatus 301 determines a second transmitter configuration based on the channel feature of the first channel (340). In some embodiments, a configuration generation algorithm may be preconfigured at the first apparatus 301, and the first apparatus 301 may obtain the second transmitter configuration based on the configuration generation algorithm. For example, an input of the configuration generation algorithm is the channel feature, and an output is the second transmitter configuration.

In some embodiments, the configuration generation algorithm may also be referred to as a configuration generation network model, a configuration generation neural network, a configuration generation network, a configuration model, another name, or the like. This is not limited. For example, the configuration generation algorithm may be pre-trained, and the trained configuration generation algorithm is preconfigured at the first apparatus 301.

In some embodiments, the second transmitter configuration may include a second processing block configuration, and the second processing block configuration may represent a processing granularity for signal processing. For example, the second processing block configuration may indicate a quantity of frequency domain resources and a quantity of time domain resources. For example, the second processing block configuration may indicate n RBs and m OFDM symbols, where n=n2, and m=m2, and is represented as, for example, PB=(n2, m2).

In this embodiment, the second processing block configuration can reflect a current frequency/time domain feature of the first channel. It may be understood that, when frequency/time domain selectivity of a channel is high, larger values of n2 and m2 may be selected. However, the larger values of n2 and m2 may cause larger calculation overheads. Therefore, in an actual determining process, processing capabilities of the first apparatus 301 and the second apparatus 302 need to be balanced. In other words, the second processing block configuration can be used to represent the frequency/time domain feature of the first channel and the processing capabilities of the first apparatus 301 and the second apparatus 302. In this way, scalability and reusability can be improved. For example, a value of n2 may be 1, 2, 4, or 8, and a value of m2 may be 1, 2, N_{symb}/2, or N_{symb}. For example, the second processing block configuration may occupy 4 bits.

In some embodiments, the second transmitter configuration may include a second channel feature codeword, and the second channel feature codeword may indicate a quantization result of a channel feature. In some examples, the second channel feature codeword may have a first preset length, to balance precision and transmission overheads. For example, if a length exceeds the first preset length, although the precision can be improved, the transmission overheads are excessively high. On the contrary, if a length is less than the first preset length, although the transmission overheads are low, the precision is low. In an example, the first preset length is 32 bits, that is, the second channel feature codeword may be equal to 32 bits.

In some embodiments, the second transmitter configuration may include a second channel awareness mask. The second channel awareness mask may indicate a location that is of a time-frequency resource and at which a predetermined modulation scheme is used in a single processing block. For example, the second channel awareness mask may include an index of a frequency domain resource and an index of a time domain resource. For example, the frequency domain resource includes a PRB, a PRE, or a subcarrier, and the time domain resource includes any one of the following: a symbol, a subframe, or a slot. For example, the predetermined modulation scheme may be any one of ASK, PSK, FSK, QAM, and the like.

In an example, it is assumed that the frequency domain resource is a subcarrier, the time domain resource is a symbol, and the predetermined modulation scheme is QAM. Then, the second channel awareness mask may indicate a subcarrier index and a symbol index, to indicate that QAM is to be used at these locations. It may be understood that the use of an irregular constellation point during channel mismatch may cause a performance loss of a transmitter. In this embodiment, the second channel awareness mask can indicate a location at which the predetermined modulation scheme (for example, QAM) is used, which can reduce the performance loss without retraining.

In some examples, the second channel awareness mask may have a second preset length, to balance precision and transmission overheads. For example, if a length exceeds the second preset length, although the precision can be improved, the transmission overheads are excessively high. On the contrary, if a length is less than the second preset length, although the transmission overheads are low, the precision is low. In an example, the second preset length is 26 bits, that is, the second channel awareness mask may be equal to 26 bits.

The first apparatus 301 sends the second transmitter configuration 352 to the second apparatus 302 (350). Optionally, in some embodiments, the first apparatus 301 may alternatively have (for example, store) the first transmitter configuration. The first apparatus 301 may compare the second transmitter configuration 352 with the first transmitter configuration. If it is determined that the second transmitter configuration 352 and the first transmitter configuration are different, the first apparatus 301 sends the second transmitter configuration 352. If it is determined that the second transmitter configuration 352 and the first transmitter configuration are the same, the first apparatus 301 may not send the second transmitter configuration 352.

For example, the first apparatus 301 may send the second transmitter configuration 352 through a second channel, where the second channel is a control channel. For example, the first apparatus 301 is implemented on a terminal side, the second apparatus 302 is implemented on a network side, and the second channel may be a physical uplink control channel (PUCCH). For example, the first apparatus 301 is implemented on a network side, the second apparatus 302 is implemented on a terminal side, and the second channel may be a physical downlink control channel (PDCCH). For example, both the first apparatus 301 and the second apparatus 302 are implemented on a terminal side, and the first channel may be a physical sidelink control channel (PSCCH).

Accordingly, the second apparatus 302 receives a second transmitter configuration 352 (354). In some examples, the second transmitter configuration 352 includes a second processing block configuration. Optionally, the second transmitter configuration 352 may further include a second channel feature codeword or a second channel awareness mask.

In some embodiments, the second transmitter configuration 352 may include a second channel feature codeword. In an example, the second apparatus 302 may use the second channel feature codeword for a subsequent data processing process. In another example, the second apparatus 302 may determine a long-term channel feature based on the second channel feature codeword, and use the determined long-term channel feature for a subsequent data processing process. It may be understood that the second channel feature codeword may be used as prior information of the long-term channel feature. It may be understood that the long-term channel feature based on the second channel feature codeword may be one of inputs of the second apparatus 302, and may be an implicit variable obtained through joint training of a transmitter and a receiver. Based on this, an output of a neural network of the second apparatus 302 may be adjusted.

In some embodiments, in response to receiving the second transmitter configuration 352, the second apparatus 302 may update the original first transmitter configuration to the second transmitter configuration 352. In addition, the second transmitter configuration 352 may be used for subsequent signal transmission. For example, after receiving the second transmitter configuration 352, for another piece of to-be-sent data, the second apparatus 302 may generate another signal based on the second transmitter configuration 352 and the another piece of to-be-sent data, and send the another signal to the first apparatus 301 through the first channel. It may be understood that a signal transmission process for another piece of to-be-sent data is similar to the process 300 in FIG. 3, and details are not described herein again.

It may be understood that, with reference to the embodiment of FIG. 3, a transmitter configuration at the second apparatus 302 can be updated in real time through joint training with the first apparatus 301. For example, the first transmitter configuration at the second apparatus 302 may be updated to the second transmitter configuration, so that an output capability of the second apparatus 302 can be adjusted in real time. It can be understood that the transmitter configuration at the second apparatus can be adaptively adjusted based on an environment change between the second apparatus and the first apparatus, thereby enhancing a generalization capability for different environments. In this process, the channel feature of the first channel may be considered as an implicit variable that is obtained through joint training and that is used to describe a channel statistical feature. In this embodiment, the processing granularity is defined through the processing block configuration, so that joint transmission and reception can be performed on a plurality of physical resources, thereby improving performance of a transmitter and a receiver, reducing complexity of a model, and improving scalability of the model.

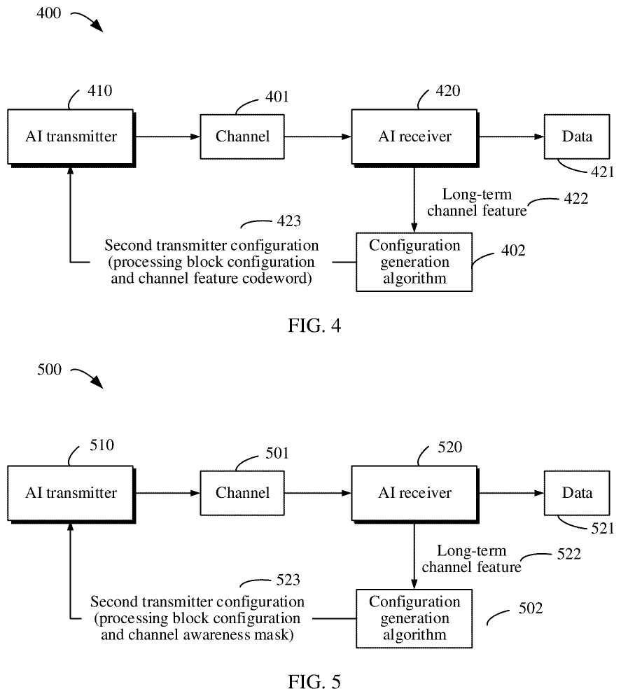

FIG. 4 is a diagram of a communication process 400 according to some embodiments. As shown in FIG. 4, an AI transmitter 410 and an AI receiver 420 are included. For example, the AI transmitter 410 may include the second apparatus 302 shown in FIG. 3, and the AI receiver 420 may include the first apparatus 301 shown in FIG. 3.

An input of the AI transmitter 410 may include a first transmitter configuration and to-be-sent data, and an output may include a signal, for example, a symbol stream. The signal may be transmitted to the AI receiver 420 through a channel 401, where the channel 401 may be a data channel. The AI receiver 420 may receive a signal that passes through the channel 401, and an output may include data 421 and a long-term channel feature 422. The long-term channel feature 422 may be input to a configuration generation algorithm 402, to obtain (that is, output) a second transmitter configuration 423. For example, the second transmitter configuration 423 in FIG. 4 includes a processing block configuration and a channel feature codeword. In addition, the second transmitter configuration 423 may be sent to the AI transmitter 410, for example, through a control channel. Optionally, the processing block configuration in the second transmitter configuration 423 may be represented by using 4-bit signaling, and the channel feature codeword in the second transmitter configuration 423 may be represented by using 32 bits.

It may be understood that the long-term channel feature 422 is one of outputs of the AI receiver 420, and optionally, may be subsequently used as one of inputs of the AI transmitter 410. It can be understood that the long-term channel feature 422 is an implicit variable obtained through joint training of a transmitter and a receiver.

FIG. 5 is another diagram of a communication process 500 according to some embodiments. As shown in FIG. 5, an AI transmitter 510 and an AI receiver 520 are included. For example, the AI transmitter 510 may include the second apparatus 302 shown in FIG. 3, and the AI receiver 520 may include the first apparatus 301 shown in FIG. 3.

An input of the AI transmitter 510 may include a first transmitter configuration and to-be-sent data, and an output may include a signal, for example, a symbol stream. The signal may be transmitted to the AI receiver 520 through a channel 501, where the channel 501 may be a data channel. The AI receiver 520 may receive a signal that passes through the channel 501, and an output may include data 521 and a long-term channel feature 522. The long-term channel feature 522 may be input to a configuration generation algorithm 502, to obtain (that is, output) a second transmitter configuration 523. For example, the second transmitter configuration 523 in FIG. 5 includes a processing block configuration and a channel awareness mask. In addition, the second transmitter configuration 523 may be sent to the AI transmitter 510, for example, through a control channel. Optionally, the processing block configuration in the second transmitter configuration 523 may be represented by using 4-bit signaling, and the channel awareness mask in the second transmitter configuration 523 may be represented by using 26 bits. In an example, the processing block configuration in the second transmitter configuration 523 may indicate (1, 1), and the channel awareness mask in the second transmitter configuration 523 may indicate [(2, 5, 8), (3, 6, 9)].

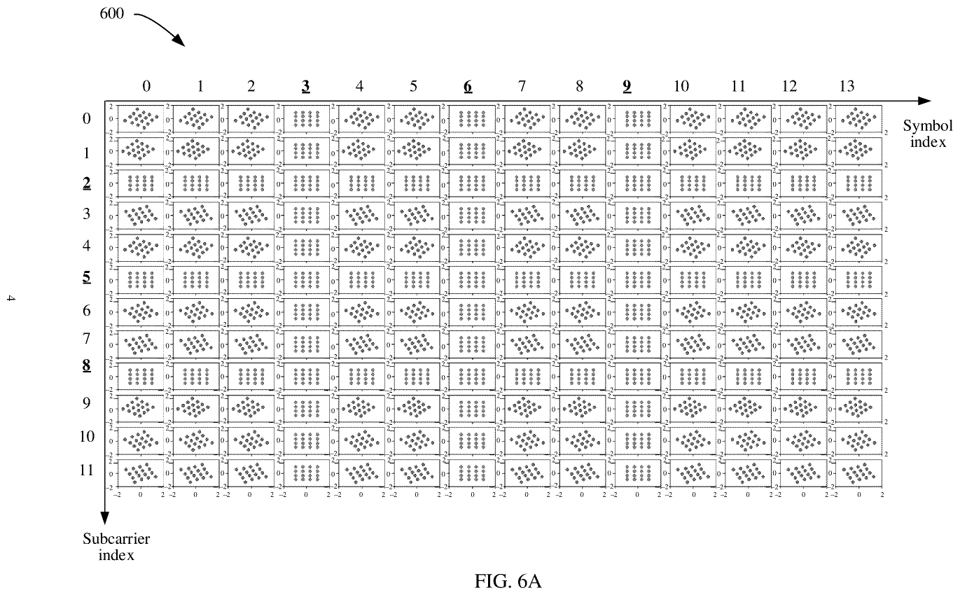

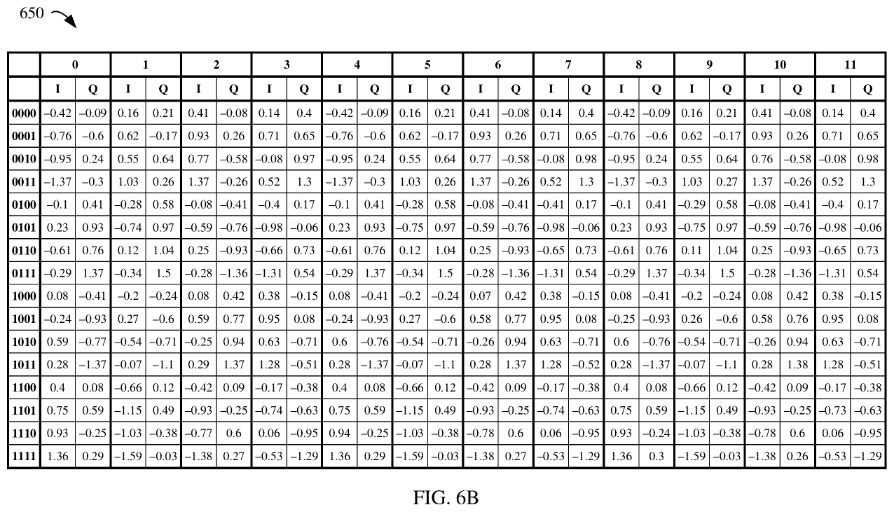

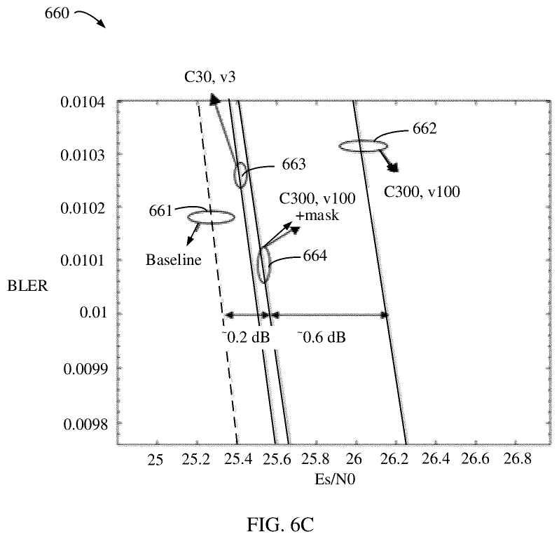

FIG. 6A is a diagram of a corresponding constellation diagram configuration 600 according to some embodiments. With reference to FIG. 5, it may be assumed that the AI transmitter 510 receives the second transmitter configuration 523 from the AI receiver 520, where the processing block configuration may indicate (1, 1), and the channel awareness mask may indicate [(2, 5, 8), (3, 6, 9)].

For example, the processing block configuration in the second transmitter configuration 523 indicates (1, 1), that is, a size of a processing block is 1 RB×1 OFDM symbol, where one RB includes twelve subcarriers. Therefore, there are a total of twelve constellation diagrams in subsequent processing at the AI transmitter 510. Refer to FIG. 6A. Twelve subcarriers whose subcarrier indexes are 0 to 11 included in any column correspond to twelve constellation diagrams, and twelve constellation diagrams in any column in FIG. 6A may be determined based on twelve irregular constellation diagrams in combination with a channel awareness mask. The channel awareness mask [(2, 5, 8), (3, 6, 9)] in the second transmitter configuration 523 may correspond to subcarrier indexes (2, 5, 8) and symbol indexes (3, 6, 9). Therefore, the AI transmitter 510 may use a predetermined modulation scheme (for example, QAM) at locations indicated by the channel awareness mask, and use an irregular constellation diagram at another location. As shown in FIG. 6A, at the locations indicated by the channel awareness mask, such as the locations of the subcarrier indexes (2, 5, 8) and the symbol indexes (3, 6, 9) shown in bold and underlined in FIG. 6A, the modulation scheme QAM is represented by a vertical straight line, and at another location, the irregular constellation diagram is represented by a non-vertical dot line.

FIG. 6B is an example of twelve irregular constellation mapping tables 650 according to some embodiments. As shown in FIG. 6B, twelve irregular constellation mapping tables are represented by indexes 0 to 11 in a first row. It may be understood that the irregular constellation mapping table is a numerical representation of the irregular constellation diagram. As shown in FIG. 6B, the irregular constellation mapping table includes two columns: in-phase (I) and quadrature (Q). In this embodiment of the present disclosure, the irregular constellation mapping table and the irregular constellation diagram may be alternately used in some scenarios. This is not limited. For example, the twelve constellation diagrams shown in any column in FIG. 6A may be determined based on the twelve irregular constellation mapping tables shown in FIG. 6B. A first column whose symbol index is 0 in FIG. 6A is used as an example. Because the subcarrier indexes indicated by the channel awareness mask in the second transmitter configuration 523 include 2, 5, and 8, the modulation scheme QAM is represented by using vertical lines at locations corresponding to the subcarrier indexes 2, 5, and 8, and the irregular constellation diagram is represented by using non-vertical dot lines at other locations.

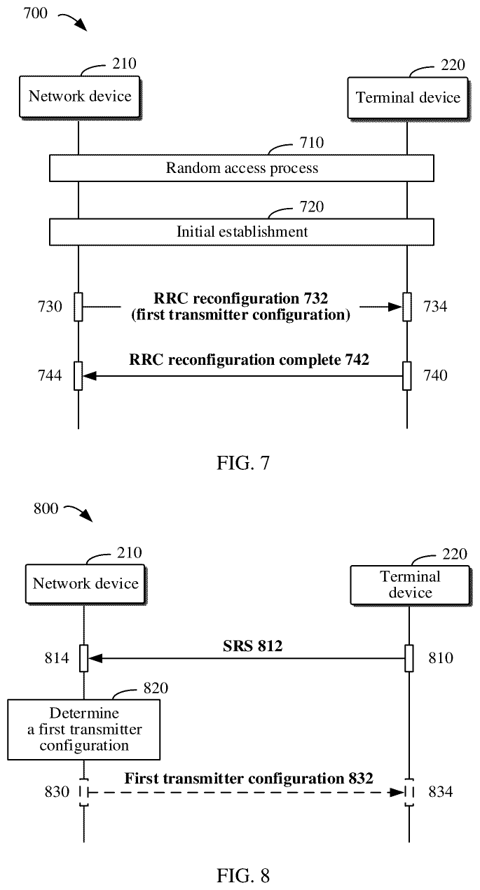

With reference to the foregoing embodiment of FIG. 3, the first transmitter configuration may be preconfigured or stored in the second apparatus 302. For example, the second apparatus 302 may be implemented on a network side or a terminal side. The following describes some possible implementations of determining the first transmitter configuration with reference to FIG. 7 to FIG. 10.

FIG. 6C is a diagram of block error ratio performance 660 according to some embodiments. In the figure, a horizontal axis indicates a ratio of signal strength (Es) to a noise power spectrum density (NO), and a vertical axis indicates a block error rate (BLER). It is assumed that a transmitter of a signal is designed in condition of a tapped delay line (TDL)-C300 and a speed of 100 kilometers per hour (km/h). In FIG. 6C, a line 661 represents an ideal baseline for performance reference. In the example of FIG. 6C, channel verification satisfies a TDL-C30 and a speed of 3 km/h.

A line 662 represents a BLER obtained through training in a condition of a TDL-C300 and a speed of 100 km/h (C300, v100). There is a channel mismatch problem in the channel verification. It can be understood that the line 662 is far away from the baseline 661, and therefore performance is poor. A line 663 represents a BLER obtained through training in a condition of a TDL-C30 and a speed of 3 km/h (C30, v3). It can be understood that the line 663 is close to the baseline 661, and therefore performance is good.

A line 664 represents a BLER obtained through training in the condition of C300 and v100 by using a solution of a channel awareness mask in this embodiment. It can be understood that, compared with the line 662, a gain of 0.6 dB can be obtained by using the solution in this embodiment, and therefore the channel mismatch problem can be alleviated. In addition, although the solution is obtained through training in the condition of C300 and v100, as shown in FIG. 6C, the line 664 is relatively close to the line 663 obtained in the condition of C30 and v3. Therefore, according to the solution in this embodiment, retraining does not need to be performed due to a condition change, which can reduce training costs, and reduce delay and overheads caused by retraining.

FIG. 7 is a schematic flowchart of a process 700 of determining a first transmitter configuration according to some embodiments. The process 700 relates to a network device 210 and a terminal device 220. In some embodiments, the network device 210 includes a first apparatus 301, and the terminal device 220 includes a second apparatus 302. In some other embodiments, the network device 210 includes a second apparatus 302, and the terminal device 220 includes a first apparatus 301.

The terminal device 220 performs (710) a random access process toward the network device 210. An initial establishment between the terminal device 220 and the network device 210 may be implemented through the random access process (720). The network device 210 sends a radio resource control (RRC) reconfiguration 732 to the terminal device 220 (730), where the RRC reconfiguration 732 includes a first transmitter configuration. Correspondingly, the terminal device 220 receives the RRC reconfiguration 732 (734). In addition, the terminal device 220 sends RRC reconfiguration complete 742 to the network device 210 (740). Correspondingly, the network device 210 receives the RRC reconfiguration complete 742 (744).

For example, before the process 730, when the terminal device 220 establishes a connection, the network device 210 can obtain a device capability of the terminal device 220, and the network device 210 may generate the first transmitter configuration based on the device capability. For example, the network device 210 can generate the first transmitter configuration based on a default configuration of an environment of the network device 210 and the device capability of the terminal device 220. For example, the network device 210 sends the first transmitter configuration to the terminal device 220 through RRC reconfiguration signaling.

FIG. 8 is a schematic flowchart of a process 800 of determining a first transmitter configuration according to some embodiments. The process 800 relates to a network device 210 and a terminal device 220. In some embodiments, the network device 210 includes a first apparatus 301, and the terminal device 220 includes a second apparatus 302. In some other embodiments, the network device 210 includes a second apparatus 302, and the terminal device 220 includes a first apparatus 301.

The terminal device 220 sends a sounding reference signal (SRS) 812 to the network device 210 (810). Correspondingly, the network device 210 receives the SRS 812 (814). The network device 210 determines a first transmitter configuration (820). In some embodiments, the network device 210 may perform uplink channel measurement by receiving the SRS 812, to determine a measurement result. In some embodiments, the network device 210 may generate the first transmitter configuration based on the measurement result and a capability of the network device 210.

Additionally or optionally, the network device 210 may send the first transmitter configuration 832 to the terminal device 220 (830). For example, the first transmitter configuration 832 may be sent through control signaling. Correspondingly, the terminal device 220 may receive the first transmitter configuration 832 (834). In some embodiments, if the terminal device 220 includes the second apparatus 302, that is, the terminal device 220 is a signal sending device, the network device 210 sends the first transmitter configuration 832 to the terminal device 220. In some other embodiments, if the network device 210 includes the second apparatus 302, that is, the network device 210 is a signal sending device, the network device 210 may send or not send the first transmitter configuration 832.

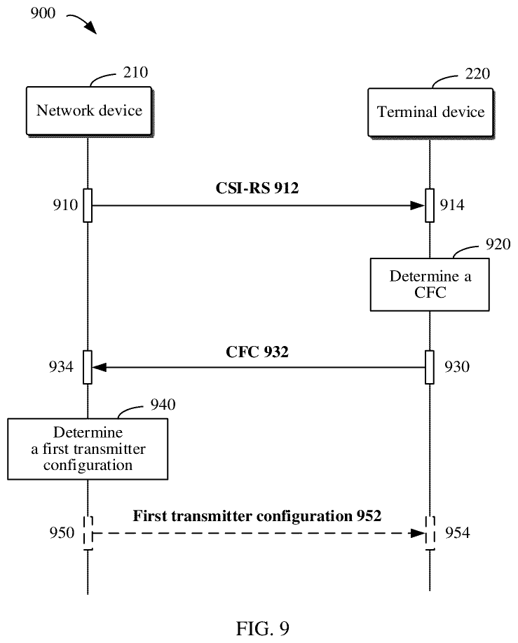

FIG. 9 is a schematic flowchart of a process 900 of determining a first transmitter configuration according to some embodiments. The process 900 relates to a network device 210 and a terminal device 220. In some embodiments, the network device 210 includes a first apparatus 301, and the terminal device 220 includes a second apparatus 302. In some other embodiments, the network device 210 includes a second apparatus 302, and the terminal device 220 includes a first apparatus 301.

The network device 210 sends a channel state information reference signal (channel state information reference signal, CSI-RS) 912 to the terminal device 220 (910). Correspondingly, the terminal device 220 receives the CSI-RS 912 (914). The terminal device 220 determines a channel feature codeword (CFC) (920). In some embodiments, the terminal device 220 may perform channel measurement based on the received CSI-RS 912, to obtain a measurement result. In some embodiments, the terminal device 220 may determine the CFC based on the measurement result and a capability of the terminal device 220.

The terminal device 220 sends the CFC 932 to the network device 210 (930). Correspondingly, the network device 210 receives the CFC 932 (934). The network device 210 determines a first transmitter configuration based on the CFC 932 (940). In some embodiments, the network device 210 may determine a long-term channel feature based on the received CFC 932. In some embodiments, the network device 210 may generate the first transmitter configuration based on the long-term channel feature and a capability of the network device 210.

Additionally or optionally, the network device 210 may send the first transmitter configuration 952 to the terminal device 220 (950). For example, the first transmitter configuration 952 may be sent through control signaling. Correspondingly, the terminal device 220 may receive the first transmitter configuration 952 (954). In some embodiments, if the terminal device 220 includes the second apparatus 302, that is, the terminal device 220 is a signal sending device, the network device 210 sends the first transmitter configuration 952 to the terminal device 220. In some other embodiments, if the network device 210 includes the second apparatus 302, that is, the network device 210 is a signal sending device, the network device 210 may send or not send the first transmitter configuration 952.

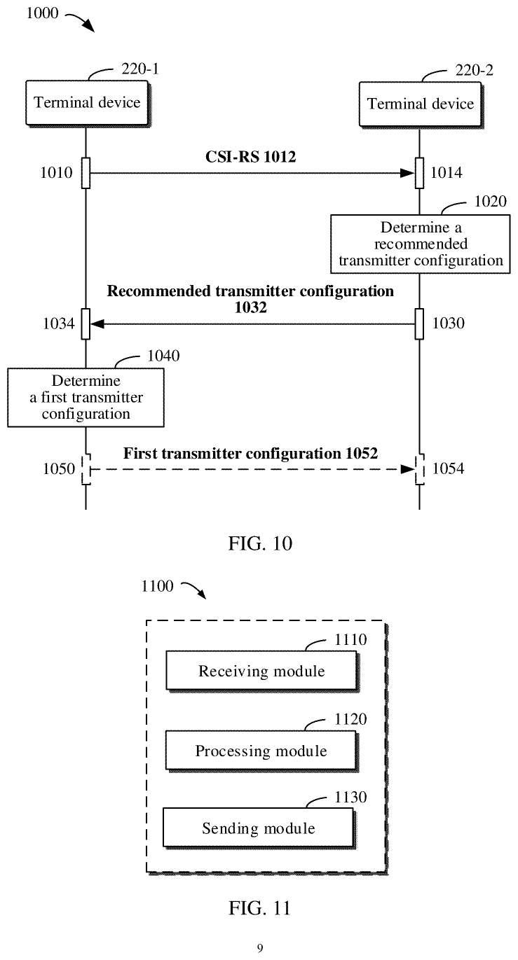

FIG. 10 is a schematic flowchart of a process 1000 of determining a first transmitter configuration according to some embodiments. The process 1000 relates to a terminal device 220-1 and a terminal device 220-2. In some embodiments, the terminal device 220-1 includes a first apparatus 301, and the terminal device 220-2 includes a second apparatus 302. In some other embodiments, the terminal device 220-1 includes a second apparatus 302, and the terminal device 220-2 includes a first apparatus 301.

The terminal device 220-1 sends a CSI-RS 1012 to the terminal device 220-2 (1010). Correspondingly, the terminal device 220-2 receives the CSI-RS 1012 (1014). The terminal device 220-2 determines a recommended transmitter configuration (1020). In some embodiments, the terminal device 220-2 may perform channel measurement based on the received CSI-RS 1012, and further determines the recommended transmitter configuration based on a measurement result. For example, the recommended transmitter configuration includes a CFC.

The terminal device 220-2 sends the recommended transmitter configuration 1032 to the terminal device 220-1 (1030). Correspondingly, the terminal device 220-1 receives the recommended transmitter configuration 1032 (1034). The terminal device 220-1 determines a first transmitter configuration based on the recommended transmitter configuration 1032 (1040). In some embodiments, the terminal device 220-1 may determine a long-term channel feature based on the received recommended transmitter configuration 1032. In some embodiments, the terminal device 220-1 may generate the first transmitter configuration based on the long-term channel feature and a capability of the terminal device 220-1.

Additionally or optionally, the terminal device 220-1 may send the first transmitter configuration 1052 to the terminal device 220 (1050). For example, the first transmitter configuration 1052 may be sent through control signaling. Correspondingly, the terminal device 220-2 may receive the first transmitter configuration 1052 (1054). In some embodiments, if the terminal device 220-2 includes the second apparatus 302, that is, the terminal device 220-2 is a signal sending device, a network device 210 sends the first transmitter configuration 1052 to a terminal device 220. In some other embodiments, if the terminal device 220-1 includes the second apparatus 302, that is, the terminal device 220-1 is a signal sending device, the terminal device 220-1 may send or not send the first transmitter configuration 1052.

In this way, various possible implementations of determining a first transmitter configuration are provided in the embodiments of FIG. 7 to FIG. 10. Therefore, a more accurate manner of obtaining or configuring a first transmitter configuration can be provided.

It should be understood that, in embodiments, “first”, “second”, “third”, and the like are only intended to indicate that a plurality of objects may be different, but two objects may be the same. “First”, “second”, “third”, and the like should not be construed as any limitation on embodiments.

It should be further understood that division into the manners, cases, categories, and embodiments in embodiments is only intended for ease of description, and should not constitute a particular limitation. The features in the manners, categories, cases, and embodiments may be combined with each other if or when logical.

It should be further understood that the foregoing content is only intended to help a person skilled in the art better understand embodiments, and is not intended as limiting their scope. A person skilled in the art may make various modifications, variations, combinations, or the like based on the foregoing content. A modified, changed, or combined solution also falls within the scope of embodiments.

It should be further understood that the foregoing content descriptions focus on differences between embodiments. For same or similar parts, refer to each other. For brevity, details are not described herein again.

FIG. 11 is a schematic block diagram of a communication apparatus 1100 according to some embodiments. The apparatus 1100 may be implemented as a network device 210 or a terminal device 220, or may be implemented as a part (for example, a chip) of the network device 210 or the terminal device 220. This is not limited. For example, the communication apparatus 1100 may be implemented as a receiving apparatus configured to receive a signal, for example, the first apparatus 301 in FIG. 3. For example, the communication apparatus 1100 may include a receiver, or may be implemented as a receiver. As shown in FIG. 11, the apparatus 1100 may include a receiving module 1110, a processing module 1120, and a sending module 1130.

The receiving module 1110 is configured to receive a signal from a second apparatus through a first channel, where the signal is generated by the second apparatus based on a first transmitter configuration. The processing module 1120 is configured to determine a channel feature of the first channel based on the signal. The processing module 1120 is further configured to determine a second transmitter configuration based on the channel feature, where the second transmitter configuration indicates at least a processing block configuration, and the processing block configuration indicates a processing granularity for performing signal processing. The sending module 1130 is configured to send the second transmitter configuration to the second apparatus.

In some embodiments, the second transmitter configuration further indicates a channel feature codeword that indicates a quantization result of the channel feature. In some embodiments, the second transmitter configuration further indicates a channel awareness mask that indicates a location that is of a time-frequency resource and at which a predetermined modulation scheme is used in a single processing block. For example, the channel awareness mask includes an index of a frequency domain resource and an index of a time domain resource. In some embodiments, the processing block configuration includes a quantity of frequency domain resources and a quantity of time domain resources. Optionally, the frequency domain resource includes a PRB, a PRE, or a subcarrier, and the time domain resource includes any one of the following: a symbol, a subframe, or a slot.

The processing module 1120 of the apparatus 1100 may be further configured to determine the first transmitter configuration; and the sending module 1130 may be further configured to send the first transmitter configuration to the second apparatus.

Optionally, in some examples, the communication apparatus 1100 is used on a network side, and the second apparatus is used on a terminal side. The receiving module 1110 may be further configured to obtain a device capability of the second apparatus in a process in which the second apparatus performs random access; and the processing module 1120 may be further configured to determine the first transmitter configuration based on the device capability of the second apparatus.

Optionally, in some examples, the communication apparatus 1100 is used on a network side, and the second apparatus is used on a terminal side. The receiving module 1110 may be further configured to receive a sounding reference signal from the second apparatus; and the processing module 1120 may be further configured to determine the first transmitter configuration based on the sounding reference signal through uplink channel measurement.

Optionally, in some examples, the communication apparatus 1100 is used on a network side, and the second apparatus is used on a terminal side. The sending module 1130 may be further configured to send a channel state information reference signal to the second apparatus; the receiving module 1110 may be further configured to receive a first channel feature codeword from the second apparatus, where the first channel feature codeword is determined by the second apparatus based on the channel state information reference signal; and the processing module 1120 may be further configured to determine the first transmitter configuration based on a channel feature recovered from the first channel feature codeword.

Optionally, in some examples, both the communication apparatus 1100 and the second apparatus are used on a terminal side. The sending module 1130 may be further configured to send a channel state information reference signal to the second apparatus; the receiving module 1110 may be further configured to receive a recommended transmitter configuration from the second apparatus, where the recommended transmitter configuration is determined by the second apparatus based on the channel state information reference signal; and the processing module 1120 may be further configured to determine the first transmitter configuration based on the recommended transmitter configuration.

The apparatus 1100 in FIG. 11 can be configured to implement the processes implemented by the first apparatus 301 in the foregoing embodiments. For brevity, details are not described herein again.

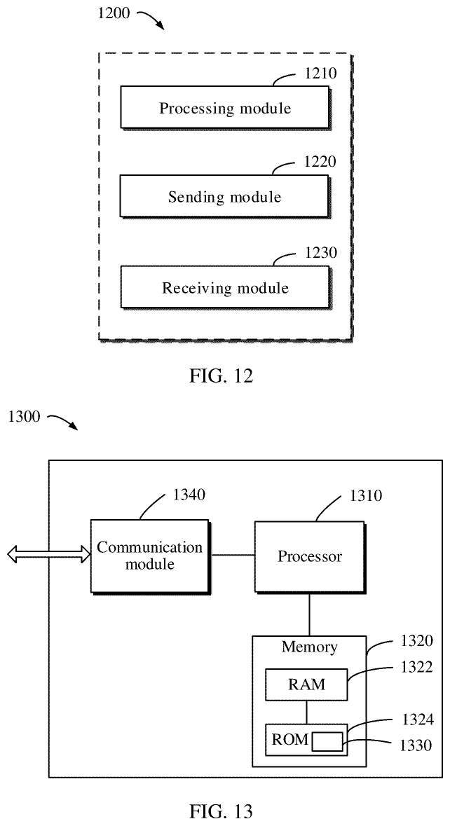

FIG. 12 is a schematic block diagram of a communication apparatus 1200 according to some embodiments. The apparatus 1200 may be implemented as a network device 210 or a terminal device 220, or may be implemented as a part (for example, a chip) of the network device 210 or the terminal device 220. This is not limited. For example, the communication apparatus 1200 may be implemented as a sending apparatus configured to send a signal, for example, the second apparatus 302 in FIG. 3. For example, the communication apparatus 1200 may include a transmitter, or may be implemented as a transmitter. As shown in FIG. 12, the apparatus 1200 may include a processing module 1210, a sending module 1220, and a receiving module 1230.

The processing module 1210 is configured to generate a signal based on a first transmitter configuration and to-be-sent data. The sending module 1220 is configured to send the signal to a first apparatus through a first channel. The receiving module 1230 is configured to receive a second transmitter configuration from the first apparatus, where the second transmitter configuration indicates at least a processing block configuration, and the processing block configuration indicates a processing granularity for performing signal processing.

In some embodiments, the second transmitter configuration further indicates a channel feature codeword that indicates a quantization result of the channel feature. In some embodiments, the second transmitter configuration further indicates a channel awareness mask that indicates a location that is of a time-frequency resource and at which a predetermined modulation scheme is used in a single processing block. For example, the channel awareness mask includes an index of a frequency domain resource and an index of a time domain resource. In some embodiments, the processing block configuration includes a quantity of frequency domain resources and a quantity of time domain resources. Optionally, the frequency domain resource includes a PRB, a PRE, or a subcarrier, and the time domain resource includes any one of the following: a symbol, a subframe, or a slot.

In some embodiments, the first transmitter configuration indicates a first processing block configuration and a first channel awareness mask. The processing module 1210 may be configured to: divide the to-be-sent data into a plurality of processing blocks based on the first processing block configuration; and for to-be-sent data in each of the plurality of processing blocks, generate the signal by using a predetermined modulation scheme at a location that is of a time-frequency resource and that is indicated by the first channel awareness mask and using another modulation scheme different from the predetermined modulation scheme (for example, an irregular constellation mapping table) at another location.

Optionally, in some examples, the first apparatus is used on a network side, and the communication apparatus 1200 is used on a terminal side. The sending module 1220 may be further configured to send a sounding reference signal to the first apparatus; and the receiving module 1230 may be further configured to receive the first transmitter configuration from the first apparatus.

Optionally, in some examples, the first apparatus is used on a terminal side, and the communication apparatus is used on a network side. The receiving module 1230 may be further configured to receive a sounding reference signal from the first apparatus; and the processing module 1210 may be further configured to determine the first transmitter configuration based on the sounding reference signal.

Optionally, in some examples, the first apparatus is used on a network side, and the communication apparatus 1200 is used on a terminal side. The receiving module 1230 may be further configured to receive a channel state information reference signal from the first apparatus; the processing module 1210 may be further configured to determine a first channel feature codeword based on the channel state information reference signal; the sending module 1220 may be further configured to send the first channel feature codeword to the first apparatus; and the receiving module 1230 may be further configured to receive the first transmitter configuration from the first apparatus.

Optionally, in some examples, the first apparatus is used on a terminal side, and the communication apparatus 1200 is used on a network side. The sending module 1220 may be further configured to send a channel state information reference signal to the first apparatus; the receiving module 1230 may be further configured to receive a first channel feature codeword from the first apparatus, where the first channel feature codeword is determined by the first apparatus based on the channel state information reference signal; and the processing module 1210 may be further configured to determine the first transmitter configuration based on a channel feature recovered from the first channel feature codeword.

Optionally, in some examples, both the first apparatus and the communication apparatus 1200 are used on a terminal side. The receiving module 1230 may be further configured to receive a channel state information reference signal from the first apparatus; the processing module 1210 may be further configured to determine a recommended transmitter configuration based on the channel state information reference signal; the sending module 1220 may be further configured to send the recommended transmitter configuration to the first apparatus; and the receiving module 1230 may be further configured to receive the first transmitter configuration from the first apparatus.

Optionally, in some examples, both the first apparatus and the communication apparatus 1200 are used on a terminal side. The sending module 1220 may be further configured to send a channel state information reference signal to the first apparatus; the receiving module 1230 may be further configured to receive a recommended transmitter configuration from the first apparatus, where the recommended transmitter configuration is determined by the first apparatus based on the channel state information reference signal; and the processing module 1210 may be further configured to determine the first transmitter configuration based on the recommended transmitter configuration.

The apparatus 1200 in FIG. 12 can be configured to implement the processes implemented by the second apparatus 302 in the foregoing embodiments. For brevity, details are not described herein again.

It may be understood that division into modules or units in embodiments is an example and is merely logical function division, and there may be another division manner during actual implementation. In addition, functional units in embodiments may be integrated into one unit, or may exist alone physically, or two or more units may be integrated into one unit. The integrated unit may be implemented in a form of hardware, or may be implemented in a form of a software functional unit.

FIG. 13 is a schematic block diagram of an example device 1300 that may be used to implement an embodiment. The device 1300 may be implemented as or included in the network device 210 in FIG. 2. Alternatively, the device 1300 may be implemented as or included in the terminal device 220 in FIG. 2. As shown in the figure, the device 1300 includes one or more processors 1310, one or more memories 1320 coupled to the processor 1310, and a communication module 1340 coupled to the processor 1310.

The communication module 1340 may be configured to perform bidirectional communication. The communication module 1340 may have at least one communication interface for communication. The communication interface may include any interface necessary for communicating with another device.

The processor 1310 may be any type applicable to a local technology network, and may include, but is not limited to, at least one of: a general-purpose computer, a dedicated computer, a microcontroller, a digital signal processor (DSP), a control-based computer, or a controller-based multi-core controller architecture. The device 1300 may have a plurality of processors, such as an application-specific integrated circuit chip, which in time belongs to a clock synchronized with a main processor.

The memory 1320 may include one or more non-volatile memories and one or more volatile memories. An example of the non-volatile memory includes, but is not limited to, at least one of: a read-only memory (ROM) 1324, an erasable programmable read-only memory (EPROM), a flash memory, a hard disk drive, a compact disc (CD), a digital versatile disc (DVD), or other magnetic storage and/or optical storage. Examples of the volatile memory include, but are not limited to, at least one of the following: a random access memory (RAM) 1322, or another volatile memory that does not persist during power-off duration.

A computer program 1330 includes computer-executable instructions performed by an associated processor 1310. The program 1330 may be stored in the ROM 1324. The processor 1310 may perform any proper action and processing by loading the program 1330 into the RAM 1322.

Embodiments may be implemented using the program 1330, so that the device 1300 can perform any process discussed above. Embodiments may alternatively be implemented by using hardware or a combination of software and hardware.

The program 1330 may be tangibly included in a non-transitory computer-readable medium, and the non-transitory computer-readable medium may be included in the device 1300 (for example, in the memory 1320) or another storage device that is accessible by the device 1300. The program 1330 may be loaded from the non-transitory computer-readable medium to the RAM 1322 for execution. The non-transitory computer-readable medium may include any type of tangible non-volatile memory, for example, a ROM, an EPROM, a flash memory, a hard disk drive, a CD, or a DVD.

In some embodiments, the communication module 1340 in the device 1300 may be implemented as a transmitter and a receiver (or a transceiver), and may be configured to send/receive a transmission signal and the like. In addition, the device 1300 may further include one or more of a scheduler, a controller, and a radio frequency/antenna. Details are not described herein, but are readily understood by a person of ordinary skill in the art.

For example, the device 1300 in FIG. 13 may be implemented as a communication apparatus, or may be implemented as a chip or a chip system in a communication apparatus. This is not limited.

An embodiment further provides a chip. The chip may include an input interface, an output interface, and a processing circuit. In embodiments, the input interface and the output interface may complete signaling or data exchange, and the processing circuit may complete generation and processing of signaling or data information.

An embodiment further provides a chip system, including a processor, configured to support a device to implement functions in any one of the foregoing embodiments. In a possible design or implementation, the chip system may further include a memory, configured to store necessary program instructions and data. When the processor runs the program instructions, a device in which the chip system is installed is enabled to implement the method in any one of the foregoing embodiments. For example, the chip system may include one or more chips, or may include a chip and another discrete device.

An embodiment further provides a processor, configured to be coupled to a memory. The memory stores instructions. When the processor runs the instructions, the processor is enabled to perform the method and the function in any one of the foregoing embodiments.

An embodiment further provides a computer program product including instructions. When the computer program product runs on a computer, the computer is enabled to perform the method and the function in any one of the foregoing embodiments.

An embodiment further provides a non-transitory computer-readable storage medium. The non-transitory computer-readable storage medium stores computer instructions. When a processor runs the instructions, the processor is enabled to perform the method and the function in any one of the foregoing embodiments.

An embodiment further provides a communication system, including a first apparatus and a second apparatus. For example, the first apparatus is the communication apparatus 1100 shown in FIG. 11, and the second apparatus is the communication apparatus 1200 shown in FIG. 12. For example, the communication system may include a network device and a terminal device that communicate with each other. For another example, the communication system includes two terminal devices that communicate with each other.

Additionally, various embodiments may be implemented by hardware or a dedicated circuit, software, logic, or any combination thereof. Some aspects may be implemented by hardware, and other aspects may be implemented by firmware or software that may be executed by a controller, a microprocessor, or another device. Although various aspects of embodiments are shown and described as block diagrams and flowcharts, or represented by some other figures, it should be understood that the blocks, apparatuses, systems, techniques, or methods described in the embodiments may be implemented as, for example, non-limiting examples, hardware, software, firmware, dedicated circuits or logic, general-purpose hardware, controllers, other devices, or a combination thereof.

The embodiments further provide at least one computer program product tangibly stored in a non-transitory computer-readable storage medium. The computer program product includes computer-executable instructions, such as instructions included in a program module, which are executed in a device on a real or virtual target processor to perform the process/method as described above with reference to the accompanying drawings. The program module can include a routine, a program, a library, an object, a class, a component, a data structure, or the like that executes a specific task or implements a specific abstract data type. In various embodiments, functions of the program modules may be combined or split between the program modules as required. Machine-executable instructions for the program module may be executed locally or in a distributed device. In the distributed device, the program module may be locally located and located in a remote storage medium.

Computer program code for implementing the method of the embodiments may be written in one or more programming languages. The computer program code may be provided for a processor of a general-purpose computer, a dedicated computer, or another programmable data processing apparatus, so that when the program code is executed by the computer or the another programmable data processing apparatus, functions/operations specified in the flowcharts and/or block diagrams are implemented. The program code may be executed entirely on a computer, partly on a computer, as a standalone software package, partly on a computer and partly on a remote computer, or entirely on a remote computer or a server.

In a context of the embodiments, the computer program code or related data may be carried in any proper carrier, so that the device, the apparatus, or the processor can perform various processing and operations described above. Examples of the carrier include a signal, a computer-readable medium, and the like. Examples of the signal may include an electrical signal, an optical signal, a radio signal, a voice signal, or other forms of propagated signals, such as a carrier wave and an infrared signal.

The computer-readable medium may be any tangible medium that includes or stores programs used for or related to an instruction execution system, apparatus, or device. The computer-readable medium may be a computer-readable signal medium or a computer-readable storage medium. The computer-readable medium may include, but is not limited to, an electronic, magnetic, optical, electromagnetic, infrared, or semiconductor system, apparatus or device, or any suitable combination thereof. More detailed examples of the computer-readable storage medium include an electrical connection with one or more wires, a portable computer disk, a hard disk drive, a random access memory (RAM), a read-only memory (ROM), an erasable programmable read-only memory (EPROM or a flash memory), an optical storage device, a magnetic storage device, or any suitable combination thereof.

In addition, although the operations of the methods in the embodiments are described in a particular order in the accompanying drawings, this does not require or imply that these operations need to be performed in the particular order, or that all the operations shown need to be performed to achieve the desired results. Instead, execution orders of the steps depicted in the flowcharts may change. Additionally or alternatively, some steps may be omitted, a plurality of steps may be combined into one step for execution, and/or one step may be broken down into a plurality of steps for execution. It should further be noted that, the features and functions of two or more apparatuses according to the embodiments may be specific in one apparatus. Instead, features and functions of one apparatus described above may be further specific in a plurality of apparatuses.

The foregoing has described various implementations of embodiments. The foregoing descriptions are examples, are not exhaustive, and are not limited to the described implementations. Many modifications and changes are clear to a person of ordinary skill in the art without departing from the scope and spirit of the described implementations or embodiments. Selection of the terms used herein is intended to well explain principles of the implementations, actual applications, or improvements to technologies in the market, or to enable another person of ordinary skill in the art to understand the implementations and embodiments.

1. A method, comprising:
receiving, by a first apparatus, a signal from a second apparatus through a first channel, wherein the signal is generated by the second apparatus based on a first transmitter configuration;
determining, by the first apparatus, a channel feature of the first channel based on the signal;
determining, by the first apparatus, a second transmitter configuration based on the channel feature, wherein the second transmitter configuration indicates at least a processing block configuration, and the processing block configuration indicates a processing granularity for performing signal processing; and
sending, by the first apparatus, the second transmitter configuration to the second apparatus.

2. The method according to claim 1, wherein the second transmitter configuration further indicates a channel feature codeword that indicates a quantization result of the channel feature.

3. The method according to claim 1, wherein the second transmitter configuration further indicates a channel awareness mask that indicates a location that is of a time-frequency resource and at which a predetermined modulation scheme is used in a single processing block.

4. The method according to claim 3, wherein the channel awareness mask comprises an index of a frequency domain resource and an index of a time domain resource.

5. The method according to claim 1, wherein the processing block configuration comprises a quantity of frequency domain resources and a quantity of time domain resources.

6. The method according to claim 4, wherein the frequency domain resource comprises a physical resource block (PRB), a physical resource element (PRE), or a subcarrier; and
the time domain resource comprises one of: a symbol, a subframe, or a slot.

7. The method according to claim 1, further comprising:
determining, by the first apparatus, the first transmitter configuration; and
sending, by the first apparatus, the first transmitter configuration to the second apparatus.

8. The method according to claim 7, wherein the first apparatus is used on a network side, the second apparatus is used on a terminal side, and
determining, by the first apparatus, the first transmitter configuration comprises:
obtaining, by the first apparatus, a device capability of the second apparatus in a process in which the second apparatus performs random access; and
determining, by the first apparatus, the first transmitter configuration based on the device capability of the second apparatus.

9. The method according to claim 7, wherein the first apparatus is used on a network side, the second apparatus is used on a terminal side, and
determining, by the first apparatus, the first transmitter configuration comprises:
receiving, by the first apparatus, a sounding reference signal from the second apparatus; and
determining, by the first apparatus, the first transmitter configuration based on the sounding reference signal through uplink channel measurement.

10. The method according to claim 7, wherein the first apparatus is used on a network side, the second apparatus is used on a terminal side, and
determining, by the first apparatus, the first transmitter configuration comprises:
sending, by the first apparatus, a channel state information reference signal to the second apparatus;
receiving, by the first apparatus, a first channel feature codeword from the second apparatus, wherein the first channel feature codeword is determined by the second apparatus based on the channel state information reference signal; and
determining, by the first apparatus, the first transmitter configuration based on a channel feature recovered from the first channel feature codeword.

11. The method according to claim 7, wherein both the first apparatus and the second apparatus are used on a terminal side, and
determining, by the first apparatus, the first transmitter configuration comprises:
sending, by the first apparatus, a channel state information reference signal to the second apparatus;
receiving, by the first apparatus, a recommended transmitter configuration from the second apparatus, wherein the recommended transmitter configuration is determined by the second apparatus based on the channel state information reference signal; and
determining, by the first apparatus, the first transmitter configuration based on the recommended transmitter configuration.

12. A method, comprising:
generating, by a second apparatus, a signal based on a first transmitter configuration and to-be-sent data;
sending, by the second apparatus, the signal to a first apparatus through a first channel; and
receiving, by the second apparatus, a second transmitter configuration from the first apparatus, wherein the second transmitter configuration indicates at least a processing block configuration, and the processing block configuration indicates a processing granularity for performing signal processing.

13. The method according to claim 12, wherein the second transmitter configuration further indicates a channel feature codeword that indicates a quantization result of the channel feature.

14. The method according to claim 12, wherein the second transmitter configuration further indicates a channel awareness mask that indicates a location that is of a time-frequency resource and at which a predetermined modulation scheme is used in a single processing block.

15. The method according to claim 14, wherein the channel awareness mask comprises an index of a frequency domain resource and an index of a time domain resource.

16. The method according to claim 12, wherein the processing block configuration comprises a quantity of frequency domain resources and a quantity of time domain resources.

17. The method according to claim 15, wherein the frequency domain resource comprises a physical resource block (PRB), a physical resource element (PRE), or a subcarrier, and the time domain resource comprises one of: a symbol, a subframe, or a slot.

18. The method according to claim 12, wherein the first transmitter configuration indicates a first processing block configuration and a first channel awareness mask, and
generating, by the second apparatus, the signal based on the first transmitter configuration and the to-be-sent data comprises:
dividing, by the second apparatus, the to-be-sent data into a plurality of processing blocks based on the first processing block configuration; and
for to-be-sent data in each of the plurality of processing blocks, generating the signal by using a predetermined modulation scheme at a location that is of a time-frequency resource and that is indicated by the first channel awareness mask and another modulation scheme different from the predetermined modulation scheme at another location.

19. The method according to claim 12, wherein the first apparatus is used on a network side, the second apparatus is used on a terminal side, and
the method further comprises:
sending, by the second apparatus, a sounding reference signal to the first apparatus; and
receiving, by the second apparatus, the first transmitter configuration from the first apparatus.

20. A communication apparatus, comprising:
a receiving module that is configured to receive a signal from a second apparatus through a first channel, wherein the signal is generated by the second apparatus based on a first transmitter configuration;
a processing module that is configured to determine a channel feature of the first channel based on the signal and determine a second transmitter configuration based on the channel feature,
wherein the second transmitter configuration indicates at least a processing block configuration, and the processing block configuration indicates a processing granularity for performing signal processing; and
a sending module, configured to send the second transmitter configuration to the second apparatus.
